(19) United States
(12) Patent Application Publication
(10) Pub. No.: US 2022/0332142 A1
(43) Pub. Date: Oct. 20, 2022

(54) FOLDING BICYCLE WHEEL

(71) Applicant: Alexander Ibraheem Ibikunle ANIMASHAUN, London (GB)

(72) Inventor: Alexander Ibraheem Ibikunle ANIMASHAUN, London (GB)

(21) Appl. No.: 17/753,158

(22) PCT Filed: Aug. 22, 2020
(86) PCT No.: PCT/EP2020/073580

§ 371 Date: Feb. 22, 2022

(30) Foreign Application Priority Data
Aug. 23, 2019 (GB) 1912147.4
Jan. 16, 2020 (GB) 2000656.5

(51) Int. Cl. B60B 19/04; B60B 1/00; B60B 25/02; B60B 27/02

(52) U.S. Cl. CPC B60B 19/04; B60B 1/003; B60B 25/02; B60B 27/023

(57) ABSTRACT

A bicycle wheel includes a hub, a rim and spoke members extending between the hub and the rim; the hub comprising a plurality of hub members, wherein the wheel comprises three or more sectors, each sector comprising a circumferential rim section, an axial hub member and one or more spoke members extending between the hub member and the rim portion, wherein the wheel may be moved between a deployed configuration and a fully collapsed configuration, wherein in the deployed configuration the rim portions form a continuous circular rim of the wheel, wherein in the fully collapsed configuration the rim portions are arranged side by side in an axially adjacent arrangement, and wherein the hub members engage and form an axially expandable or collapsible hub.

### BACKGROUND OF THE INVENTION

This invention relates to a folding wheel for a bicycle, particularly but not exclusively for a bicycle with a collapsible or foldable frame.

Folding bicycles are useful for transportation on public transport or in private or other vehicles in which space is restricted. Difficulty with existing folding bicycles is that the minimum size in the collapsed or folded configuration is restricted by the size of the wheels. For this reason folding bicycles have been provided with wheels with having a much smaller diameter than normal bicycles. While the smaller wheels may facilitate collapse of the frame to a smaller size, such wheels are less desirable as they are less comfortable and may be unsafe for use on bumpy or irregular surfaces, for example when there are bumps, potholes, drainage culverts and the like.

KR20120096761 discloses a foldable bicycle wheel formed from three wheel members which may be folded into a collapsed position in which the segments overlap for ease of transportation.

WO2019108051 discloses a foldable bicycle consisting of a folding box, folding handles and folding wheels.

### SUMMARY OF THE INVENTION

According to a first aspect of the present invention a bicycle wheel comprises a hub, a rim and spoke members extending between the hub and the rim; the hub comprising a plurality of hub members;

wherein the wheel comprises three or more sectors, each sector comprising a circumferential rim portion, an axial hub member and one or more spoke members extending between the hub member and the rim portion;

wherein the wheel may be moved between a deployed configuration and a fully collapsed configuration;

wherein in the deployed configuration the rim portions form a continuous circular rim of the wheel;

wherein in the fully collapsed configuration the rim portions are arranged side by side in an axially adjacent arrangement; and

wherein the hub members engage and form an axially expandable or collapsible hub.

In a preferred embodiment the sectors are equiangular. In a preferred embodiment three sectors are employed, each forming an angle of about 120° around the wheel axis.

The spoke member may comprise a plurality of discrete spokes. Alternatively a segment shaped spoke member may be provided and arranged to form a complete disk in combination with segment shaped members of the other wheel segments. The spoke members may each comprise a laminar portion extending between the hub member and rim portion.

The hub may be an internally geared hub. A planetary geared hub system may be employed, as is commonly known in the art.

The hub may include a shaft extending axially of the wheel; and

a collar located co-axially around the shaft, the collar comprising three or more part cylindrical collar members, one or more of the collar members being axially slidable and rotatable in relation to the other collar members.

Each hub member may comprise a respective collar member. The collar member may form the hub member or may extend radially outwardly from the hub member. The collar member may be integral with the hub member.

The hub member may comprise an annular portion, for example a ring having a diameter selected to form a sliding fit with the shaft; the collar member being integral with the hub member.

Preferably three collar members are provided. Preferably two of the three collar members are slideable relative to the shaft.

In a first embodiment, the collar members directly engage the shaft so that the collar members are in slidable contact with the shaft. A lubricant may be employed.

In an alternative embodiment, a bearing may be located between the shaft and collar members. The bearing may be annular and may comprise one or more cylindrical sleeves surrounding the shaft and having an inner surface in slidable contact with the shaft and an outer surface in slidable contact with an inner surface of the respective collar.

The bearing may comprise a plain cylindrical sleeve composed of a low friction material. Polymeric materials, for example, polytetrafluoroethylene (Rulon registered trade mark), polyamide (Nylon registered trade mark), polyacetal or polyether ketone. Composites including carbon or glass fibres may be employed. Alternatively, a metal backed sleeve may be provided with a polymeric coated surface. A sleeve bearing manufactured by IGUS, for example, a jGlide bearing may be employed.

In an alternative embodiment, the bearing may comprise inner and outer surfaces which are connected by a ball race.

Use of a bearing reduces any friction between the collar and shaft and avoids possible jamming in use. Use of a lubricant may not be necessary.

Each collar member may be axially slidable in relation to one or two other collar members.

Each collar member may be axially rotatable in relation to one or two other collar members.

Each collar member may be provided with a respective bearing.

Three collar members may be arranged to engage to form a sleeve which completely or partially encloses the shaft in the deployed configuration of the wheel.

Each of the three collar members may extend over an equal angle about the axis.

For example, three collar members may each extend over an angle of about 120°.

The three collar members may engage to form a sleeve which completely surrounds the shaft, particularly in the deployed configuration of the wheel.

The sleeve may comprise a cylindrical channel located around the shaft.

Each collar member may comprise a body having a part-cylindrical internal surface and one or more mountings for a spoke member, for example two spokes, of a respective rim portion.

Longitudinal movement of a collar member along the hub shaft or rotational movement of a collar member about the axis of the hub shaft causes corresponding movement of the wheel segment, comprising the spoke member and rim section.

In an embodiment, a first collar member is integral with or secured to the hub shaft, the first collar member extending outwardly from the shaft, and having first and second engagement surfaces extending parallel to the axis of the shaft, each of the engagement surfaces being arranged for slidable engagement with a corresponding engagement surface of an adjacent collar member.

A second collar member may be longitudinally, axially and rotatably slidable in relation to the shaft and first collar member also longitudinally, axially and rotationally slidable in relation to the third collar member.

The third collar member may be longitudinally, axially and rotatably slidable in relation to the first collar member and shaft and also longitudinally, axially and rotatably slidable in relation to the second collar member.

The three collar members may each provide a part cylindrical channel having a diameter to receive the shaft and having parallel, axially extending external surfaces and one or more mountings for spoke members.

Each engagement surface may include a formation configured to engage a complementary formation of a corresponding engagement surface of an adjacent collar member.

In an embodiment one or more projections may be dimensioned to be received in one or more complementary recesses in the adjacent engagement surface.

The or each projection may comprise one or more axially extending ribs or splines. Alternatively an array of discrete projections may be employed.

The or each projection may extend tangentially to the axis, for example having a planar, laminar configuration.

Alternatively the or each projection may extend at a constant radius from the axis, that is having a cylindrical profile. For example, the projection may have a cylindrical laminar profile in radial cross section.

Provision of a tangentially extending or planar laminar projection together with a complementary configured and dimensioned recess or slot in the adjacent collar member, may constrain the collar members to longitudinal- or axial-sliding movement relative to each other, preventing rotational movement relative to each other.

Provision of a projection with a constant radial distance from the axis, that is cylindrical in radial cross section with a correspondingly shaped slot or recess, allows a collar member to be rotated into and out of engagement with the adjacent collar member and also to permit longitudinal or axial sliding of one member relative to the other.

The engagement surfaces may be planar or curved in cross-sectional profile.

Preferably the adjacent engagement surfaces have complementary configurations to permit engagement of the surfaces in use.

In an advantageous embodiment, first, second and third collar members are arranged around the cylindrical shaft member;

the first collar member being secured to or integral with the shaft and having first and second engagement surfaces arranged to engage and cooperate with a third engagement surface of a second collar member and a fourth engagement surface of a third collar member respectively; and

a fifth engagement surface of the second collar member being arranged to engage a sixth engagement surface of the third collar member.

When the engagement surfaces are engaged in this way, the second, third or both collar members may move slidingly along the shaft relative to each other and/or the first collar member and are prevented from axial rotation by abutment of each collar member between engagement surfaces of the two adjacent collar members.

In an embodiment the engagement surfaces of the first collar member have projections or recesses extending at a constant radius, so that the projections and recesses are part cylindrical in radial cross-section.

The first collar member may have one or more of: two recesses, one on each engagement surface; two projections, one on each engagement surface; or one projection and one engagement on one projection and one engagement surface and one recess on the other engagement surface.

Conveniently the first collar member may have two recesses located between the shaft and the first collar member. Such an arrangement has the advantage that the projections extend over the surface of the shaft, increasing the area of engagement to improve the accuracy of movement, strength of the hub arrangement and reducing any likelihood of wear or damage in use.

The second and third collar members may have a planar, longitudinally-extending engagement member and recess. This arrangement permits the second and third collar members to be longitudinally, axially slidable along the shaft without becoming separated and disengaged from each other.

The arrangement also permits one of the second or third collar members to be slidably disengaged from both of the other collar members. This arrangement may facilitate movement of the wheel from the deployed configuration to the folded configuration.

The second and third collar members may slide axially along the shaft in opposite directions.

A locking member may secure one or both of the collar members to the shaft. The locking member may comprise a spring biased pin arrangement. The pin may extend through a radially extending bore in the body of the second or third collar member and be received in a socket in the shaft, the pin being biased, for example by a spring, into the engaged position in which the pin is engaged within the socket so that movement of the collar relative to the shaft is prevented.

The pin may be threaded or may have a bayonet fitting to prevent inadvertent disengagement from the shaft.

The pin may be integral with a locking member. For example, the locking member may be hollow or may have an axial bore, the pin being captive in the bore and urged outwardly by a spring. Alternatively, the pin may be separate from the locking member and may optionally have an axial bore located within a hollow support and urged outwardly by a spring.

Alternatively, the pin may be separate from the locker member.

In an advantageous embodiment the shaft may include one or more channels, the channels being configured to guide a pin as the respective collar member is moved axially along the shaft. The channel may be configured to engage an end of the pin as the collar member is moved axially outwardly of the hub between the deployed position and towards the fully collapsed position.

The guide pin may be captive in a bore within the collar member and urged radially inwardly towards the shaft by a spring or other resilient means. The distance of the extension of the pin into the channel in the shaft may be limited by the radial depth of the channel.

In an advantageous embodiment a first channel in the shaft serves to guide the movement of the guide pin extending radially inwardly from the second hub member, the first channel extending parallel to the axis of the shaft for a first distance and between a first end and a second end and extending circumferentially from the second end at a constant location on the wheel axis.

In this arrangement a collar member, for example the second collar member may be located on the shaft and the pin engaged within the channel. The pin constrains the movement of the second collar when the wheel is moved from the deployed position, so that the second collar member is slidably moved initially in an axial direction with the pin moving along the first part of the channel parallel to the wheel axis. This movement disengages the second hub portion from the first hub portion. The recess and/or projection of the first engagement surface is disengaged from the projection and/or recess of the third engagement surface.

In this configuration the second hub portion is free to rotate with the pin guided circumferentially along the second part of the channel. Rotation of the second hub member causes the spoke member and rib portion to rotate from the axial location of the deployed position towards the fully retracted position.

In an advantageous embodiment a second channel in the surface of the shaft serves to guide movement of the third hub member.

The first section of the second channel extends along the surface of the shaft in a spiral configuration and a second section of the second channel extends at a constant axial location along the wheel axis.

In order to disengage the engagement surface of the third hub member from the second engagement surface of the first hub member, the third hub member is twisted causing the third hub member to move in a spiral path along the shaft with the pin engaged in the first spinal-shaped part of the second channel.

When the pin reaches the second, circumferentially extending part of the second channel, the third hub member, the spoke member and rim portion may be rotated about the wheel axis from the angular location of the deployed position towards the fully collapsed position in which the three wheel segments may be located side by side in axially spaced relation.

In an embodiment a hub securing socket is provided at each end of the channel, wherein the pin engages in the socket in the deployed configuration and in the folded configuration. This is useful to prevent the sectors from unexpectedly swinging back on a person's fingers or hand during transportation of the folded wheel.

The hub shaft may have a constant diameter so that the slideable collar members may slide from the deployed position towards a collapsed position.

In an alternative embodiment, the shaft may include a central region having a diameter selected to form a close sliding fit with the hub member and collar member; and

at least one outer region having a smaller diameter selected to permit easier movement of the hub member and collar member over the outer region during movement from the deployed position towards a collapsed position.

The use of one or both outer regions having a diameter which is smaller, for example about 95% of the central diameter, facilitates outward movement of the hub and collar members towards the collapsed configuration.

The central outer diameter portion and outward smaller diameter portion may each have a constant diameter, a shoulder of increasing diameter connecting the two portions to guide the hub and collar members into a correct orientation on the central shaft portion.

Use of smaller diameter outer portions reduces the need for high tolerance machining of the outer portions and reduces the amount of material required. Also, the weight of the wheel is reduced.

Wider wheels may be employed without an increased risk of the wheel becoming stuck during movement between the deployed and collapsed configurations.

The use of a larger central hub diameter reduces play or unwanted movement of the collar members in the fully deployed configuration.

The annular hub members may extend axially from the collar member, providing a cylindrical sleeve. An adjacent annular hub member may have a correspondingly shaped cylindrical annular cavity dimensioned to receive and securely engage the sleeve in the deployed configuration of the wheel.

The cylindrical axially inwardly facing surface of the annular hub member may be continuous with the part cylindrical axially inwardly facing surface of the collar member. This configuration improves contact of the hub and collar members with the shaft.

A collar clamp may be provided to secure the collar members in the deployed configuration of the wheel.

The clamp may be arranged to apply a radially, inwardly directed force against a radially, outwardly facing surface of the collar members in order to restrain movement of the collar members in the deployed configuration. The clamp may engage one, or more, preferably two, movable collar members. In the disclosed embodiment, the two collar members, which are movable relative to the shaft, are clamped. Clamping of the collar members provides a more secure wheel assembly in the deployed configuration and may allow for a reduction in manufacturing tolerances.

The collar clamp may comprise a projection such as a rod or shaft secured at a proximal or radially inner end to the hub shaft or first collar member, the projection extending radially outwardly from the hub shaft or collar member, a movable clamping member being located at a distal or radially outer end of the projection, wherein the clamping member may be movable between an unclamped position in which the collar members are free to move and a clamped position in which the collar members are secured, preventing movement relative to the hub shaft.

The clamping member may comprise a cam with a cam surface rotatable about a cam axis, the cam axis extending transversely relative to the projection, the radius of the cam surface relative to the cam axis changing with the angular orientation of the cam surface. This arrangement creates a clamping force during rotation of the cam surface.

The exemplary embodiments of the cam surface may be arranged to provide an over centre arrangement wherein the clamping force is greatest for maximum rotation of the cam surface is achieved.

The cam surface may comprise a generally cylindrical cam body having an actuation lever extending outwardly from the cam body. A user may apply manual pressure to the lever to rotate the cam body to open or close the clamp, for example using a finger or thumb.

A contact plate may be movably secured to the projection, having a first surface arranged to contact the cam surface and a second surface arranged to be urged into engagement with the collar members when force is exerted on the plate by rotation of the cam surface.

The contact plate may comprise a cylindrical washer having an aperture through which the projection extends.

The projection may comprise a threaded member, for example a shank of a bolt.

In an embodiment, the clamping member may comprise a cam lever arranged when rotated manually to apply a clamping force through the contact plate to the collar member or members, in order to reduce any play or rattle of the hub assembly during use. This arrangement reduces the number of moving parts which a user must interact with in collapsing or deployment of the bicycle, in relation to an arrangement comprising multiple locking pins or other more complex arrangements.

A fastener, for example a strap or clip may be provided to secure the three-wheel segments together in the fully collapsed position.

The wheel may comprise a plurality of sections, typically three sections, which engage end-to-end to form a continuous rim in deployed configuration of the wheel.

Each rim section may support a respective tyre section. Each tyre section may have end walls arranged to abut the end walls of an adjacent tyre section when the wheel is in the deployed configuration.

The tyre sections may be composed of solid elastomeric material. Pneumatic or solid foam tyres may be used. Preferably, an inner tube section may be encased in an outer tyre section. The ends of the inflatable tube sections may be formed of thicker material to support the tube sections when in the collapsed configuration of the wheel.

Adjacent rim sections may be secured together in the deployed position by a rim lock arrangement.

The rim lock may comprise a channel extending circumferentially into an end of each rim section and arranged to align with a corresponding channel extending into the end of an adjacent rim section to form a continuous channel in the deployed configuration of the wheel; a latch member being located in the channel, the latch member being slidable between a retracted position wherein the latch member is located wholly within a single channel and an extended position wherein the latch member is located partially within each channel of two adjacent rim sections.

A locking member may be arranged to prevent unwanted movement of the latch member within the channel in either or both of the extended and retracted configurations. The locking member may comprise a slidable member, for example a pin or stud received in a corresponding socket in the latch member so that the pin may be withdrawn from the latch member to permit the latch member to slide within the channel, or arranged within the latch member to prevent sliding of the latch member. The latch member may be prevented from sliding in the fully deployed position in order to retain the sections securely in alignment. In addition, the latch member may be secured in the fully withdrawn position for convenience and secure storage and transportation of the folded wheel.

The latch members may be spring loaded so that they are biased into the extended configurations when the wheel is assembled into the deployed configuration. A spring-loaded catch may be used to retain the latch members in the retracted positions until contacted with an abutment surface of the adjacent rim.

A rim clamp may be provided to secure adjacent rim sections in the deployed configuration of the wheel.

The rim lock arrangement may include a rim clamp comprising a rim clamping member which may engage surfaces of adjacent rims, and means for applying a clamping force to the rims to prevent relevant movement of the rims, for example while the bicycle is being ridden.

The latch member may include one or more projections secured to the latch member at a proximal location and extending radially outwardly through an aperture in that the rim to a distal location on the exterior of the rim section, a rim clamping means being located at a distal end of the projection.

The clamping means may comprise a cam with a cam surface rotatable about a cam axis extending transversely relative to the projection, the radius of the cam surface relative to the cam axis changing with the angular orientation of the cam surface so that a clamping force may be provided.

The cam may comprise a generally cylindrical cam body having an actuation lever extending outwardly from the cam body. A user may apply manual pressure to the lever to open or close the clamp, for example using a finger or thumb.

A contact plate may be removably secured to the projection, the contact plate having a first surface configured to contact the cam surface and a second surface configured to be urged into engagement with the rim section when force is applied by rotation of the cam surface.

The rim clamping member may include a radially, inwardly opening circumferential channel configured to receive and engage a complimentary, radially outwardly, circumferentially-extending, convex formation of the rim. This arrangement may provide more secure alignment of adjacent rim sections in use, particularly preventing lateral displacement of one rim section relative to the other.

An over centre locking arrangement may be provided to prevent accidental unlocking of the clamping arrangement during use.

According to a second aspect of the present invention, a foldable bicycle comprises a frame and two wheels;

the frame comprising two parts connected together by lockable hinges and movable between a first position in which the frame is extended for riding by a user and a second position in which the frame is folded; a front wheel detachable from the frame; and a rear wheel in accordance with the first aspect of the present invention.

According to a third aspect of the present invention, a foldable bicycle comprises a frame and two wheels;

the frame comprising two parts connected together by lockable hinges and movable between a first position in which the frame is extended for riding by a user and a second position in which the frame is folded; a front wheel and a rear wheel in accordance with the first aspect of the present invention.

When the frame is in the second position and the wheels are in the fully collapsed configuration, the collapsed hubs may be coaxially aligned or may be axially offset to provide a more compact structure.

The hinges may include locking nuts or clips to securely hold the frame in the deployed configuration.

A bicycle wheel or bicycle in accordance with the present invention confers several advantages.

The heel can be folded without interfering with the free wheel and sprocket arrangements or the brake rotor. These remain fixed in place while making folding of the wheel simple and efficient.

The engagement surfaces of the collar members provide extra strength to the wheel to resist against lateral bending forces, in use. This arrangement allows the dimensional tolerances of the hub and collar members to be less precise, reducing engineering costs and keeping the wheel less sensitive to wear in use. The use of curved engagement members allows the collar members to be rotated to lock or unlock the engagement members. Some of the engagement members may be planar. Planar engagement members may be easier and cheaper to manufacture. Planar members may be used on the second or pull, collar member because it is moved laterally into place. The engagement members may be provided with chamfers to make location and assembly easier.

The spokes do not need to be equiangularly spaced around the wheel. Spokes on the same sector may, for example be separated by an angle of about 70° and spokes on adjacent sectors may be separated by an angle of about 50°. This reduces the unsupported span of the wheel. Any convenient number of spokes may be employed. The spokes may be composed of carbon fibre or other suitable material. The use of grooves in the hub shaft enables control of the movement of the sectors to make it easier to fold the wheel from the deployed to the fully collapsed configuration. This is superior to an arrangement in which the sectors could rotate freely as it may be confusing for a user to determine which direction to fold the wheel. On one side the sector may be pushed laterally out of the plane and then rotated. On the other side the sector is turned relative to the hub the helical or spiral groove moves the sector out of the plane of the deployed configuration. The helical groove having a straight section at the end may allow the rim connector to slide and twist into the rim without an additional movement.

Alternatively both sides of the hub may have a slide then twist groove arrangement.

### BRIEF DESCRIPTION OF THE DRAWINGS

The invention is further described by means of example but not in any limitative sense with reference to the accompanying drawings of which:

FIG. 1 shows a side elevation of a wheel in accordance with the invention;

FIG. 2 shows a plan view of the wheel shown in FIG. 1;

FIG. 3 shows an exploded view of the wheel shown in FIGS. 1 to 2;

FIG. 4 shows a side elevation and perspective view of the hub of the wheel shown in FIGS. 1 to 3;

FIG. 5 is an enlarged partial cross section of the hub shown in FIG. 4;

FIG. 6 shows four side views of the hub shaft and first hub member of the wheel;

FIGS. 7 and 8 are side views of the hub shaft and hub members showing the second hub member moving from a deployed position towards a collapsed position;

FIGS. 9 and 10 are cross sectional views of the hub shaft and hub member showing the second hub member moving towards the deployed position;

FIGS. 11 to 13 are side views showing successive stages of movement, following on from FIG. 8, showing the second hub member moving to a collapsed position;

FIGS. 14 to 15 are side views showing successive stages of movement, following on from FIG. 13, showing the third hub member moving from a deployed position to a collapsed position;

FIGS. 16 to 18 show use of the rim lock arrangement;

FIGS. 19 to 23 show successive steps in folding of the wheel shown in the preceding figures;

FIG. 24 is a side view of a bike comprising the wheels in accordance with the invention;

FIG. 25 shows a side view, rear view and perspective view of the bike shown in FIG. 24 in a folded configuration;

FIGS. 26 and 27 show views of an alternative hub of the present invention;

FIGS. 28 and 292 show views of a further alternative hub including a clamping arrangement; and

FIGS. 30 and 31 show an alternative rim section including a clamping arrangement.

### DETAILED DESCRIPTION OF THE PREFERRED EMBODIMENTS

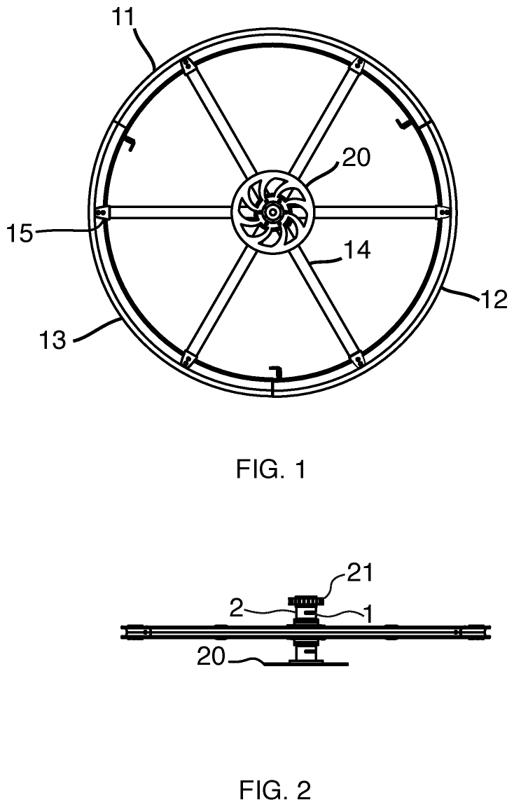

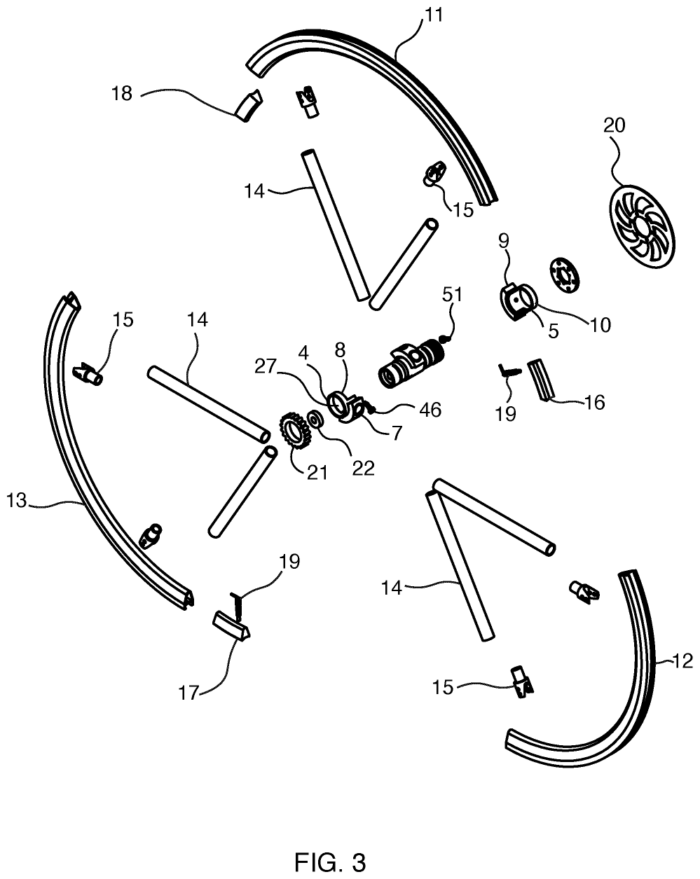

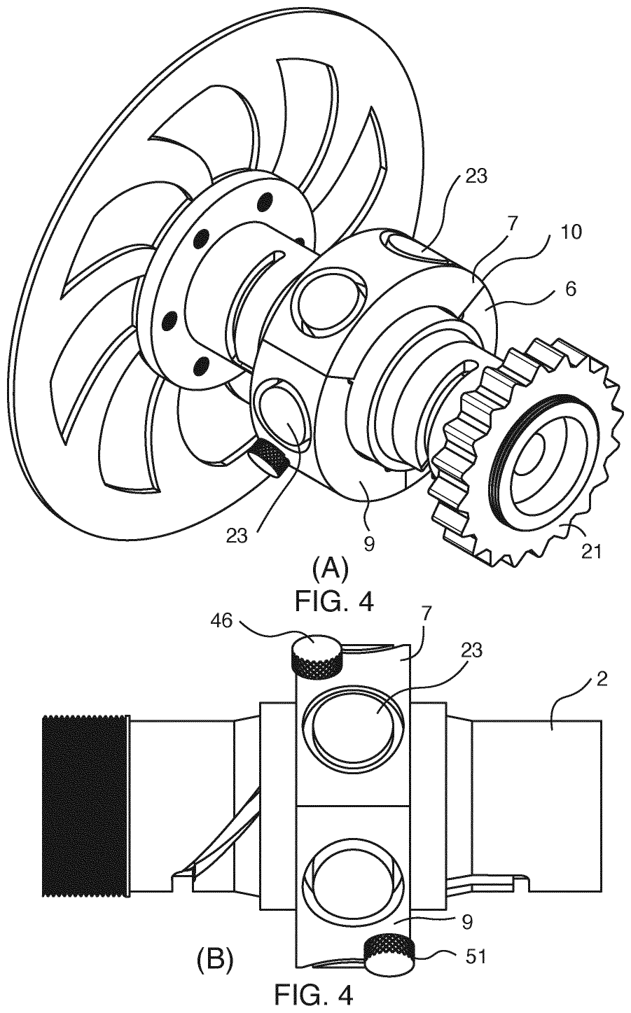

FIGS. 1 to 4 show a foldable bicycle wheel in accordance with this invention. The wheel comprises a hub (1), for example an internally geared hub (1) as is commonly known in the art. The hub (1) comprises a cylindrical hub shaft (2), a first hub member (3), a second hub member (4) and a third hub member (5). The first hub member (3) comprises a first collar member (6) secured to the hub shaft (2), the first collar member (6) extending from the first hub member (3). The second hub member (4) comprises a second collar member (7), and a circular ring (8). The third hub member (5) comprises a third collar member (9) and a circular ring (10). The first collar member (6), second collar member (7) and third collar member (9) collectively form a cylindrical collar (10).

Three rim sections (11, 12, 13) are connected to respective collar members (6, 7, 9) by pairs of tubular spoke members (14) connected to the rims by mountings (15).

Latch members (16, 17, 18) are slidably received in channels in the ends of the rim sections (11, 12, 13) respectively. One or more of the latch members (16, 17, 18) may be secured by locking members e.g. (19). One of latch members may be a fixed locking member.

A brake disc (20) and sprocket (21) with bearing (22) are mounted on the hub shaft (2).

The spoke members (14) are received in sockets (23) in each of the collar members (6, 7, 9). The sockets (23) may be circular slots.

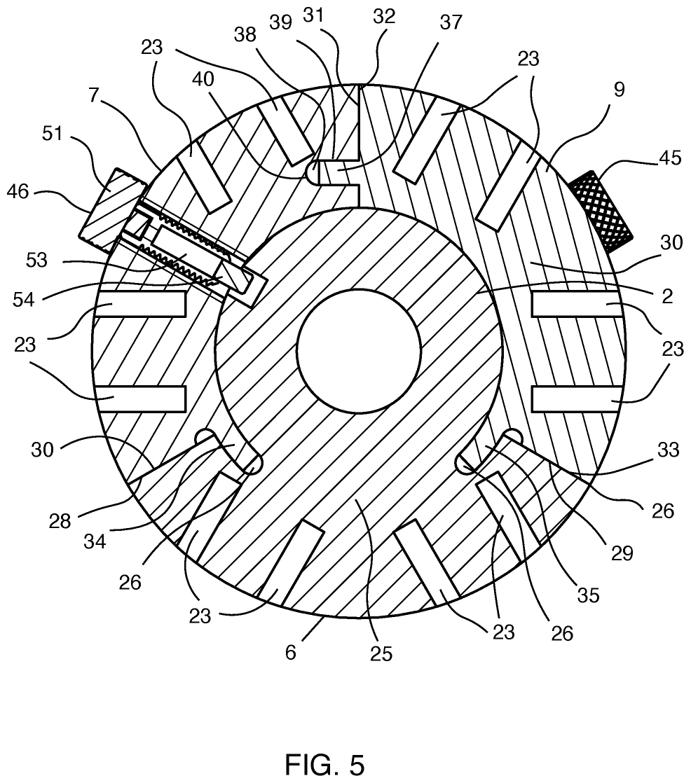

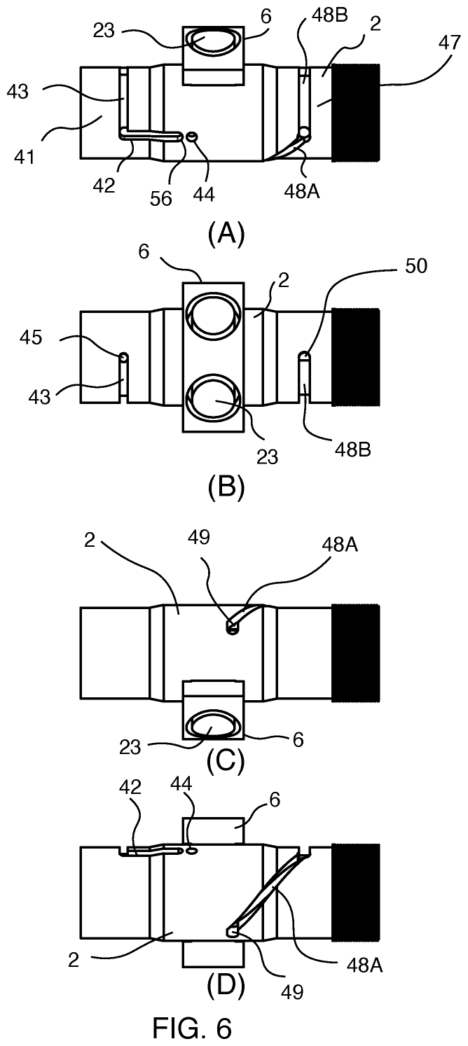

FIG. 5 shows a cross sectional view of the hub (1). The arrangement is shown in plan view, from the edge of the wheel in FIG. 6. FIG. 5 is enlarged for clarity. The hub shaft (2) is connected to the first collar member (6) by a narrow connecting portion (25) to define engagement slots (26) on either side of the first collar member (6).

The second collar member (7) has a cylindrical channel (27) dimensioned to form a sliding fit with the hub shaft (2). Radially extending, axially parallel first (28) and second (29) engagement surfaces of the first collar member (6), abut the engagement surfaces of the second (7) and third (9) collar members, discussed below. The first engagement surface (28) abuts and engages a third engagement surface (30) of second collar member (7). The third collar member (9) extends between the first (6) and second (7) collar members to complete the enclosure of the collar (10). A fourth engagement surface (31) of second collar member (7) abuts and engages a fifth engagement surface (32) of the third collar member (9). A sixth engagement surface (33) of the third collar member (9), abuts and engages the second engagement surface (29) of the first collar member (6). Each engagement surface has a projection or recess to ensure that the engagement surfaces are securely coupled together in the deployed position of the wheel.

Projections (34, 35) of the third (30) and the sixth (33) engagement surfaces extend into the engagement slots (26) of the first collar member (6). Projections (34) and (35) extend over the surface of the hub shaft (2). This arrangement improves the contact between the second (7) and third (9) collar members and the hub shaft (2), reducing any liability for wear or damage in use. The projections (34) and (35) are cylindrical in radial cross section so that the projections (34) and (35) lie against the cylindrical surface of the hub shaft (2). When the second (7) or third (9) collar members are free to rotate then the projections (34) and (35) may be withdrawn rotationally from the sockets (23), to disengage the first (28), second (29), third (30) and sixth (33) engagement surfaces. Projection (37) extending from the fifth engagement surface (32) of the third collar member (9) is received into a recess (38) of the fourth engagement surface (31) of second collar member (7). The projection (37) has parallel planar sides (39) and the recess (38) has corresponding parallel planar sides (40). The close fit between the sides (39) of a projection (37) and the sides (40) of the recess (38) prevents rotation of the third collar member (9) relative to the second collar member (7), until one of the collar members has been slidably moved along the wheel axis to disengage the fourth engagement surface (31) from the fifth engagement surface (32).

Each of the sockets (23) are configured to receive ends of the spoke members (14) so that the collar members (6, 7, 9) can support their respective rim sections (11, 12, 13) as shown in FIG. 1.

FIG. 6(a)-(d) show four views of the hub shaft (2) and the first collar member (6). A first channel (41) has a first portion (42) extending parallel to the wheel axis and a circumferential portion (43) extending around the circumference of the hub shaft (2) at a constant location along the wheel axis. First (44) and second (45) locking apertures are located at either end of the first channel (41). The first (44) and second (45) locking apertures maybe located within the first channel (41) or located offset relative to the first channel (41). The first channel (41) has a constant radial depth so that a first locking member (46) or other projection may slide smoothly along the first channel (41) in use. The first locking aperture (44) has a greater radial depth to hold the first locking member (46) or the second collar member (7) in the fully deployed position. The second locking aperture (45) also with a greater radial depth is used to hold the second collar member (7) in the fully collapsed position.

A second channel (47) extends from the centre of the hub shaft (2). The second channel has a first helically extending portion (48a) extending helically around the circumference of the surface of the hub shaft (2) and a circumferentially extending portion (48b) extending around the circumference of the surface of the hub shaft (2) at a constant location on the wheel axis. Third (49) and fourth (50) locking apertures are located at either end of the second channel (47). The third (49) and fourth (50) locking apertures maybe located within the second channel (47) or located offset relative to the second channel (47). The second channel (47) has a constant radial depth so that a second locking member (51) or other projection may slide smoothly along the second channel (47) in use. The third locking aperture (49) has a greater radial depth to hold the second locking member (51) or the third collar member (9) in the fully deployed position. The fourth locking aperture (50) also with a greater radial depth is used to hold the third collar member (9) in the fully collapsed position.

The first locking member (46), for example a pin, comprises a head (52), shaft (53) and end (54) mounted in a threaded bore (55) in the second collar member (7) so that the end (54) of the first locking member (46) is received in the first locking aperture (44) provided in the hub shaft (2). Engagement of the first locking member (46) within the threaded bore (55) so that the end (54) is received in the first locking aperture (44) prevents unwanted movement of the second hub member (4) from the fully deployed position of the wheel, discussed below. Engagement of the first locking member (46) within the threaded bore (55) so that the end (54) is received in the second locking aperture (45) prevents unwanted movement of the second hub member (4) from the fully collapsed position of the wheel, discussed below.

The second locking member (51), for example a pin, comprises the same features as the first locking member (46) and mounted in a threaded bore (not shown) of the third collar member (9) so that the end of the second locking member (51) is received in the third locking aperture (49) provided in the hub shaft (2). Engagement of the second locking member (51) within the threaded bore of the third collar member (9) so that the end of the second locking member (51) is received in the third locking aperture (49) prevents unwanted movement of the third hub member (5) from the fully deployed position of the wheel, discussed below. Engagement of the second locking member (51) within the threaded bore of the third collar member (9) so that the end of the second locking member (51) is received in the fourth locking aperture (50) prevents unwanted movement of the third hub member (5) from the fully collapsed position of the wheel, discussed below.

In an embodiment, the hub shaft (2) may only include two of the locking apertures, as described above. For example, the hub shaft (2) may include the second locking aperture (45) and the fourth locking aperture (50). By way of further example, the hub shaft (2) may include the first locking aperture (44) and the third locking aperture (49).

In another embodiment the bores (55) may not be threaded. Biasing members, such as resilient springs, may be used to bias the first (46) and second (51) locking members towards the locking apertures (44, 45, 49, 50) so that each end (54) of the locking members (46, 51) is received in one of the locking apertures (44, 45, 49, 50).

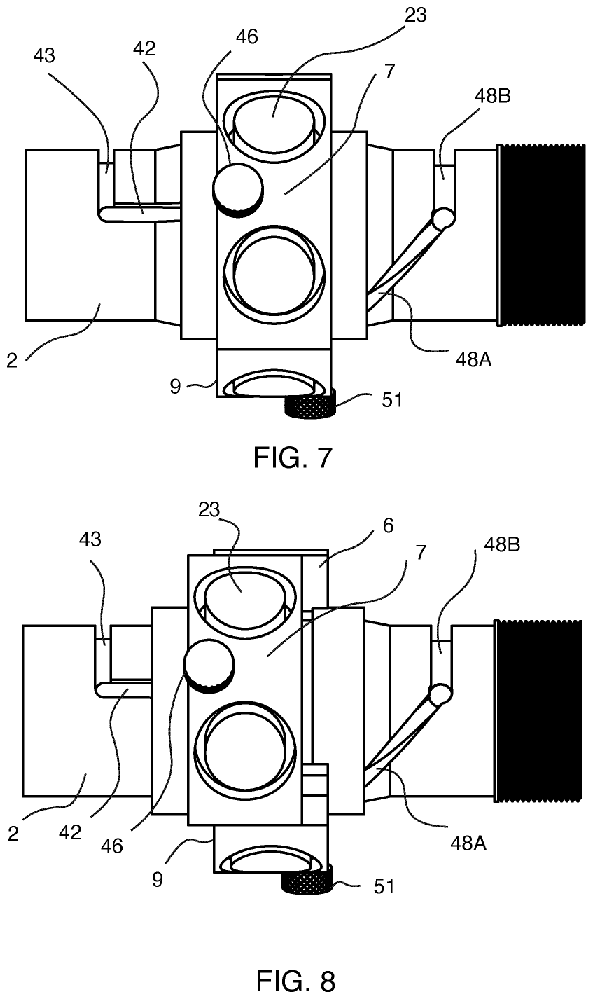

FIG. 7 shows the hub members (3, 4, 5) in the deployed position in which the locking members (46, 51) are engaged so that the collar members (6, 7, 9) completely encase the hub shaft (2). In the deployed position the first locking member (46) is received in the first locking aperture (45), preventing movement of the second hub member (4).

When the first locking member (46) is released or unscrewed from the first locking aperture (44) so that the second collar member (9) is released from the second first aperture (44) the first locking member (46) is free to move in an axial direction along the first portion (42) of the first channel (41) allowing the second collar member (7) to be pulled parallel to the wheel access away from first (3) and third (5) hub members and first (6) and second (7) collar members (to the left as shown in FIGS. 8 and 11). This movement moves the two spoke members (14) located in the sockets (23) of the second collar member (7) and the corresponding rim section (12). In this way, the wheel segment glides along the hub axis (to the left as shown in FIGS. 8 and 11. The wheel sector may then be rotated with the first locking member (46) passing circumferentially around the circumferential portion (43) of the first channel (41) until an end stop position is reached (see FIG. 13). Here the first locking member (46) may be screwed downwardly to locate the end (54) of the first locking member (46) within the second locking aperture (45) of the hub shaft (2).

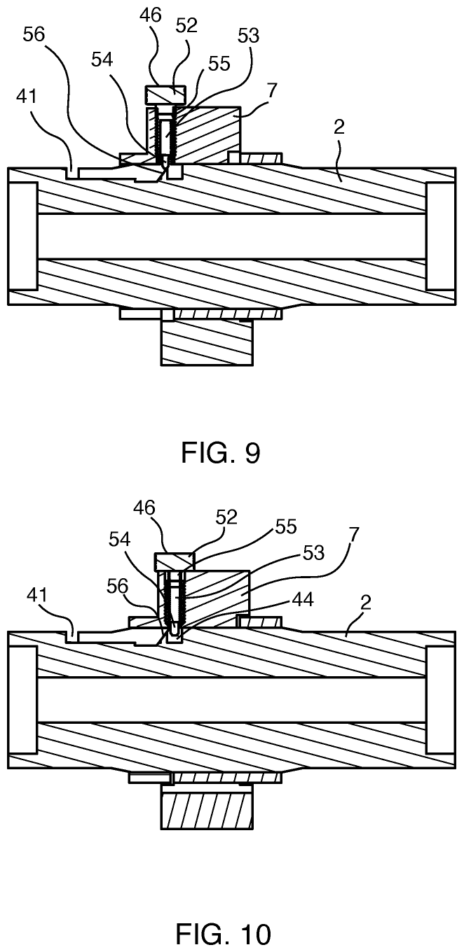

FIGS. 9 and 10 show movement of the second hub member (4) towards a fully deployed position. As the second hub member (4) moves towards the fully deployed position, the first locking member (46) is urged upwardly over an inclined ramp surface (56) so that the first locking member (46) is positioned above the first locking aperture (44) so that the first locking member (46) may be screwed downwardly into the first locking aperture (44). Alternatively, when a resilient spring is used, as described previously, the first locking member (46) is urged upwardly over an inclined ramp surface (56) so that the first locking member (46) upon moving off the ramp surface is urged downwardly into the first locking aperture by the resilient spring.

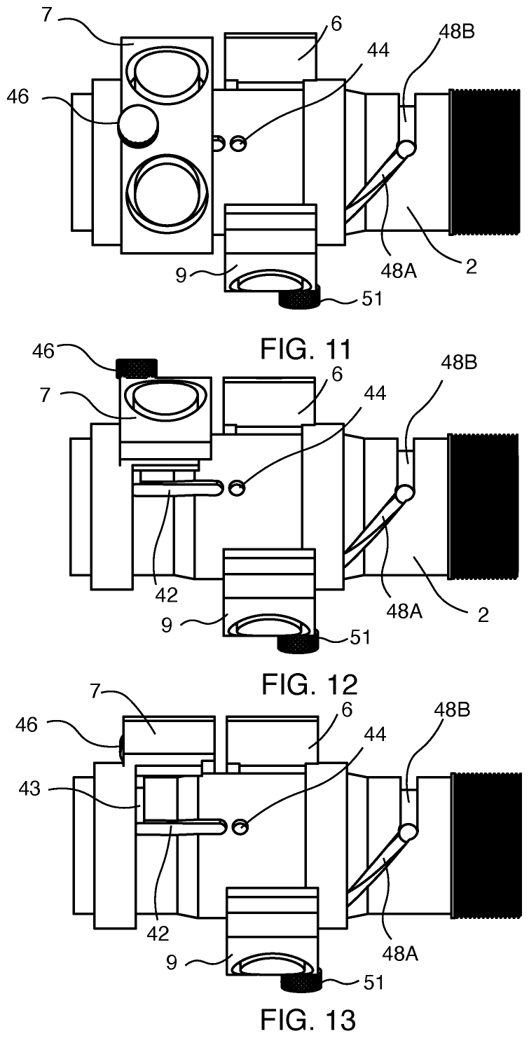

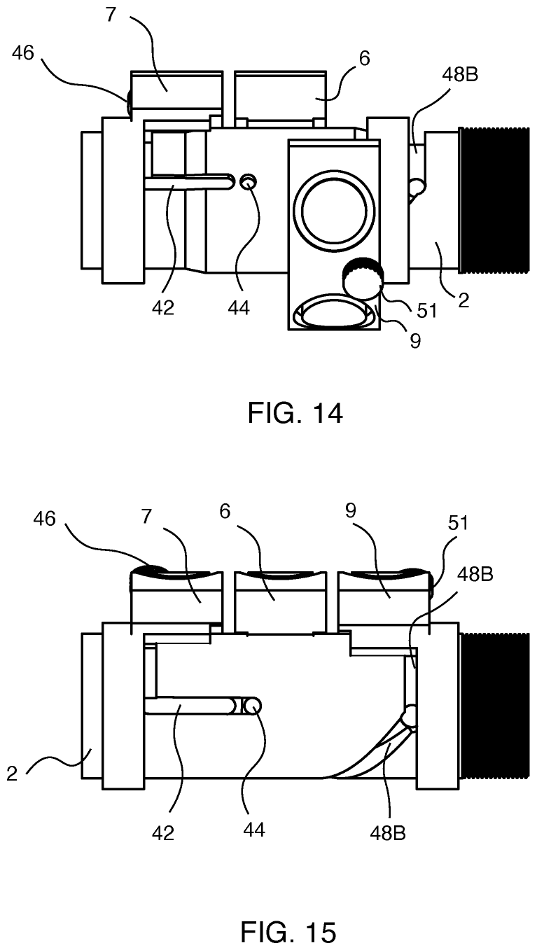

FIGS. 12 and 13 show successive stages of rotation of the second collar member (7) as the first locking member (46) moves circumferentially within the circumferentially extending portion (48) of the first channel (41). FIG. 14 shows the second collar member (7) is the fully collapsed position.

FIGS. 14 and 15 shows the movement of the third hub member (5) to the fully collapsed position. When the second locking member (51) is released or unscrewed from the third locking aperture (49) so that the third collar member (9) is released from the third locking aperture (49) the second locking member (51) is free to move in a helical direction with along the spiral circumferentially extending portion (48b) of the second channel (47). When the third hub member (5) reach the end of the spiral circumferentially extending portion (48b) the third hub member (5) may be rotated circumferentially with the second locking member (51) following the first portion (48a) of the second channel (47). This movement moves the two spoke members (14) located in the sockets (23) of the third collar member (7) and the corresponding rim section (13). In this way, the wheel segment helically glides spirally along the circumferentially extending portion (48b) of the second channel (47) in an opposite direction to the second hub member (4) (to the right as shown in FIGS. 14 and 15. The wheel sector may then be rotated with the second locking member (51) passing circumferentially around the first portion (48a) of the second channel (47) until an end stop position is reached (see FIG. 15). Here the second locking member (51) may be screwed downwardly to locate the end of the second locking member (46) within the fourth locking aperture (50) of the hub shaft (2).

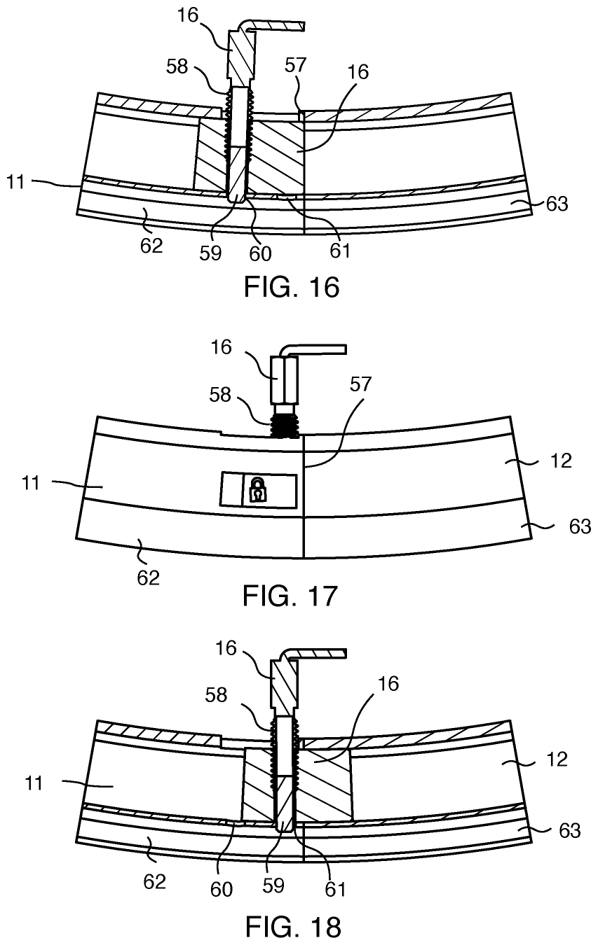

FIGS. 16 to 18 illustrate the locking and unlocking of the rims. Adjacent rim sections (11) and (12) have annular channels which abut at (57) so that channels are continuous.

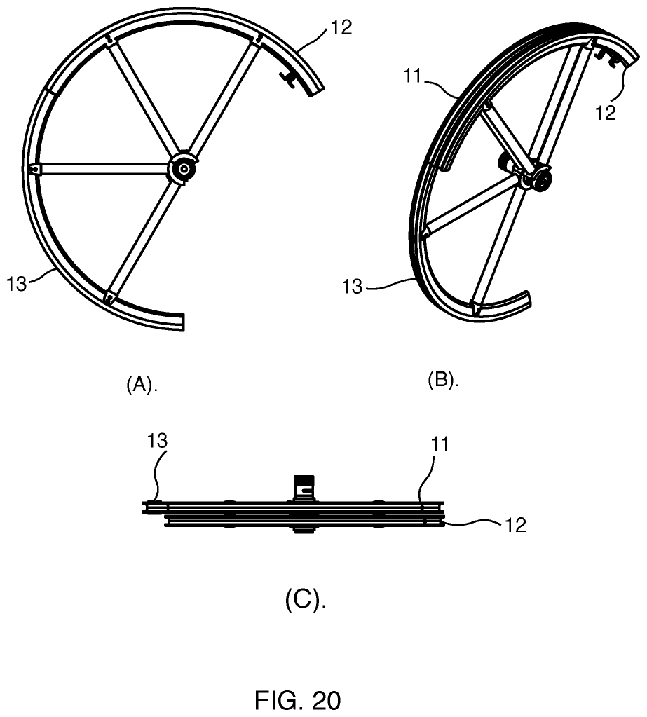

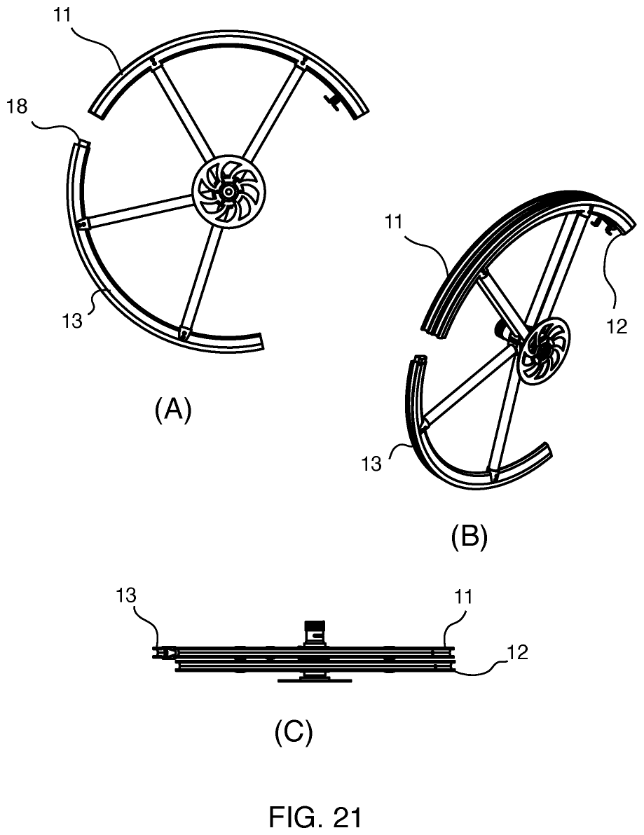

A latch member (16) is slidable along the channels and may be secured in locked or unlocked positions using a locking member (19) having a threaded shaft (58) and a locking end portion (59) which may be received in first (60) or second (61) apertures in the wall of the rim portion (11). A tyre portion (62) (63) are mounted on the outer circumference of the rim portion (11) and (12) to form a continuous tyre in the fully deployed position as shown in FIG. 20(a).

A window (64) in the side of the rim portion (11) provides a visual indication that the wheel is locked in the deployed position and may be used safely. The unlocked position in shown in FIGS. 16 and 17.

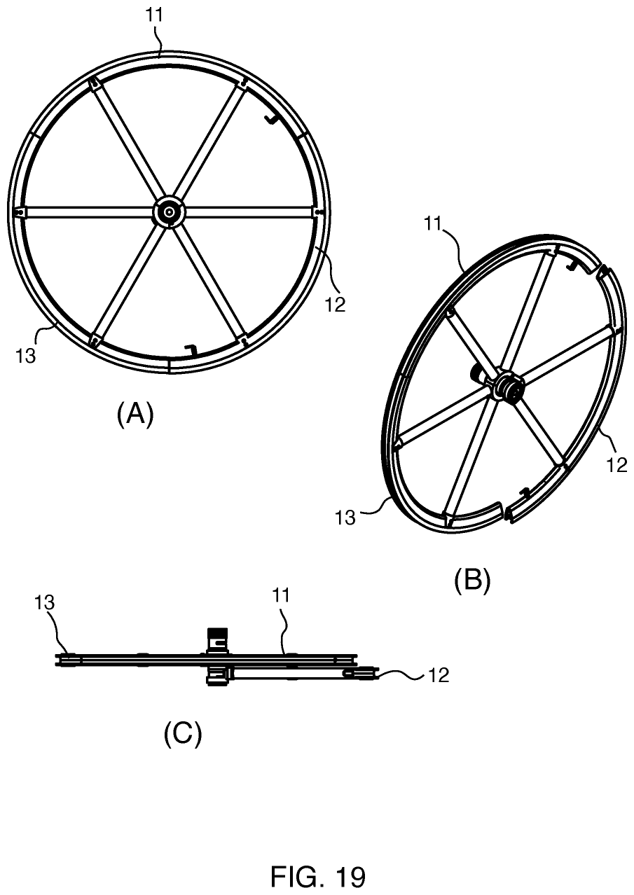

FIGS. 17 and 18 show the locked position in which the latch member (16) has been slidably moved so that it is received partially within each of the channels. The latch member (16) is secured using the locking member (19) with the locking end portion (59) received in the second aperture (61).

A latch member (17) is also located in the channels of adjacent rim sections (12) and (13) and is slidable and locked via a locking member (19) as described above. A fixed latch member (18) is also located in the channels of adjacent rim sections (13) and (11).

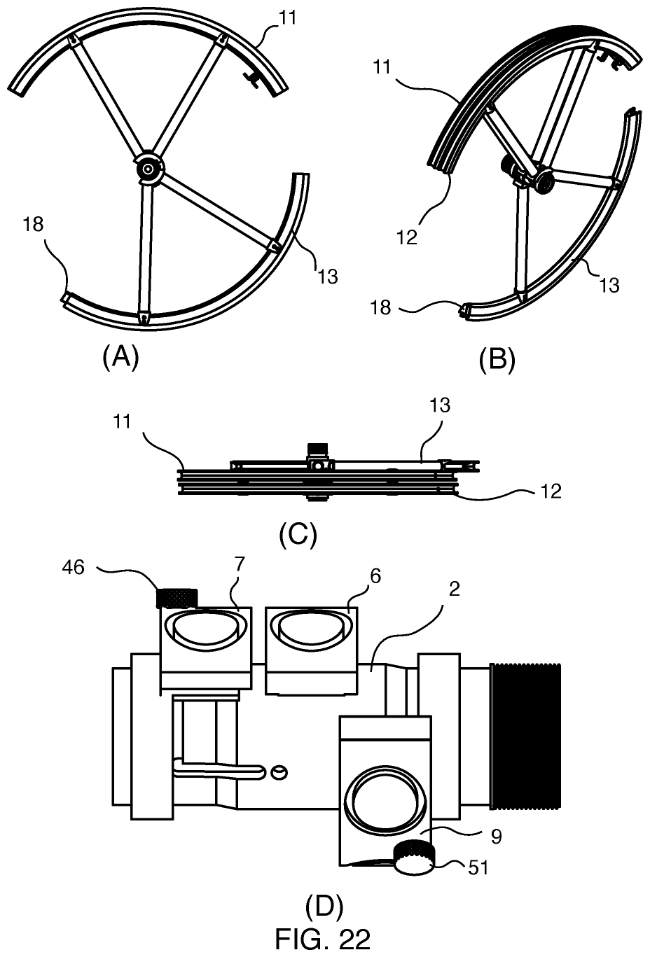

FIGS. 19 to 23 illustrate the successive stages in folding of the wheel from the deployed position to the fully collapsed position.

In FIGS. 19(a)-(c) the latch member (16) has been moved to the unlocked position (as described above) which allows the wheel sector comprising rim section (12), second hub member (4) and collar member (7) to be moved slidably moved axially along the first channel (41), as described above, so that the second hub member (4) is displayed axially from the first (3) and third (5) hub members as shown in FIG. 20(a)-(c).

In FIGS. 20(a)-(c) the second hub member (4) is rotated circumferentially (anticlockwise) along the first channel (41), as described above, so that the wheel sector including second hub member (4) are located side by side and in adjacent spaces in relation to the first rim section (11).

In FIGS. 21(a)-(c) and 22(a)-(c) the latch member (17) has been moved to the unlocked position (as described above) which allows the wheel sector comprising rim section (13), third hub member (5) and collar member (9) to be moved helically, as described above, along the second channel (47) in the opposite direction to the previous motion of the sector comprising the rim section (12), second hub member (4) and collar member (7).

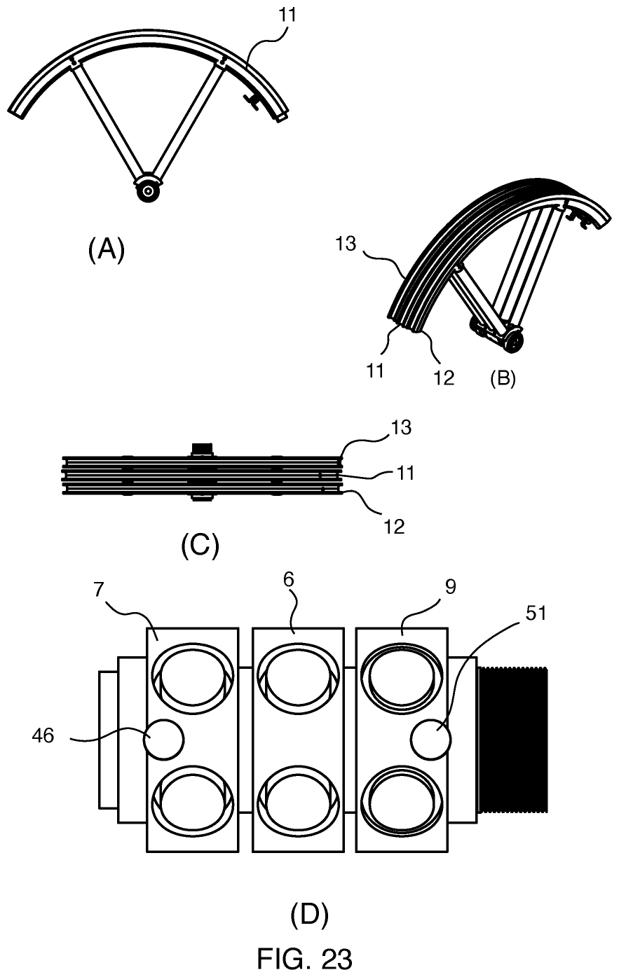

In FIG. 23(a)-(c) the three rim sections (11) (12) (13) are located side by side in adjacent space relation in fully collapsed position of the wheel.

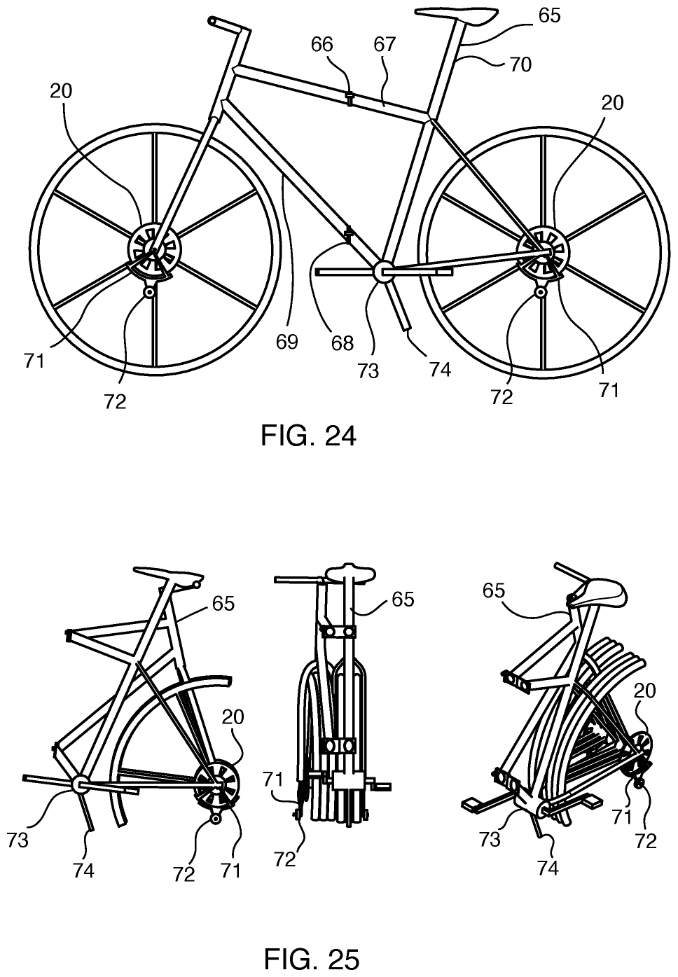

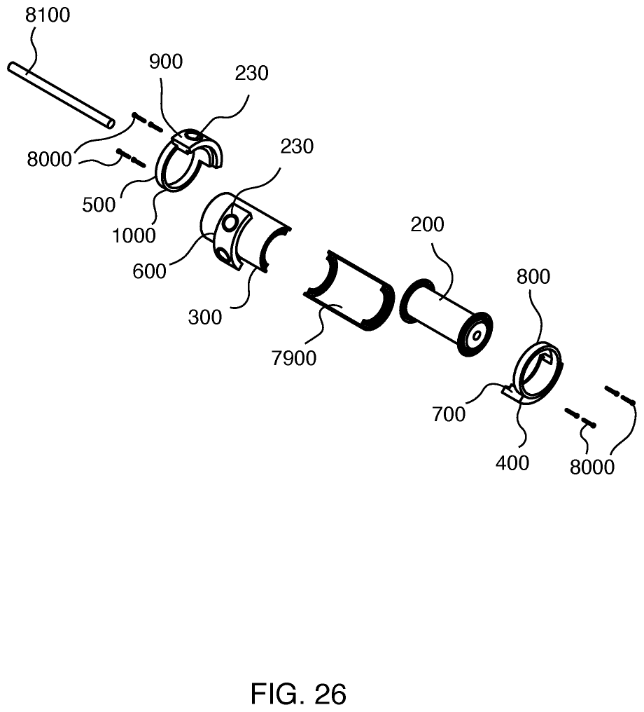

FIGS. 24 and 25 show a bike (65) comprising the foldable bicycle wheel as described above. The frame of the bike (65) comprises a first hinge (66) located on a top tube (67) and a second hinge (68) located on a bottom tube (69). The first and second hinges (66, 68) are located along a vertical plane. The frame is pivotably moveable about the first (66) and second (68) hinges from a riding configuration, as shown in FIG. 25, to folded configuration, as shown in FIG. 26. In the riding configuration releasable locking means are provided to maintain the bike in the riding configuration by preventing pivotable movement about the hinges (66, 68). A further locking means may be provided to maintain the bike (65) in the folded configuration. In the folded configuration the handles bars of the bike (65) are located adjacent the seat. If both wheels of the bike (65) are in the fully collapsed position then the rim sections (11, 12, 13) of each wheel may be positioned adjacent a seat tube (70) with each set of rim sections on opposing side of the seat tube (70). Each brake disc (20) includes a brake disc guard (71) with one or more wheels (72), for example caster wheels, depending from each brake disc guard. A bottom bracket (73) includes a stand (74), such as a peg leg stand. In use the wheels (72) and stand (74) allow the bike to freestanding when in the folded configuration. A user may hold the bike, for example by the seat or handle bars, and pull the bike along on the wheels (72).

Each rim section of a wheel in accordance with this invention comprises a separate tyre section. Each tyre section may be composed of solid elastomeric material encasing an inflatable inner tube section. Each tyre section may have a valve which extends through the corresponding rim section. The ends of each of the tyre sections may be configured to compress against each other when the wheel is in the fully deployed position so that the tyre sections form a substantially continuous tyre surface. The tyre sections may be tubular, clincher or tubeless in design as is common practice.

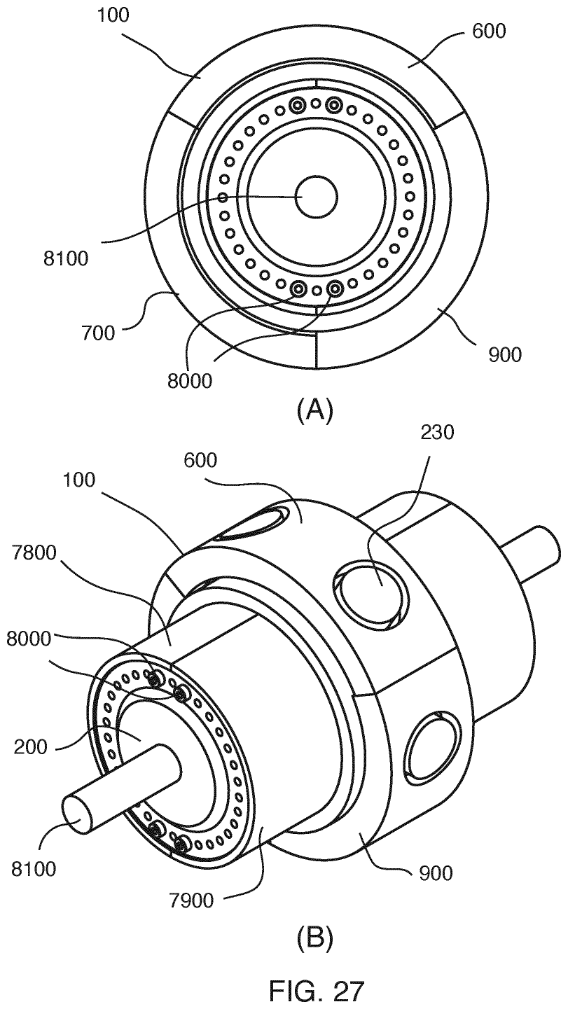

FIGS. 26 and 27 show a further embodiment of the hub (100) for use in the wheel as described above. The hub may be an internally geared hub (100) as is commonly known in the art. The hub (100) comprises a cylindrical hub shaft (200), a first hub member (300), a second hub member (400) and a third hub member (500). The first hub member (300) comprises a first collar member (600) secured to a first cylindrical shell casing (7800). The second hub member (400) comprises a second collar member (700) attached to an outer circumference of a circular ring (800). The third hub member (500) comprises a third collar member (900) attached to an outer circumference of a circular ring (1000). The first collar member (600), second collar member (700) and third collar member (900) collectively form a cylindrical collar (1000). The hub (100) further comprises a second cylindrical shell casing (7900). Both the first (7800) and second (7900) cylindrical shell casings are attached to the hub (100) via an attachment means, for example screws (8000) at both ends of the hub (100), to form a single cylindrical enclosure enclosing the cylindrical hub shaft (200). The hub (100) further comprises a pin (8100) extending longitudinally through the centre of the hub (100). The pin (8100) is connected to the gears of the hub (100) as is commonly known in the art.

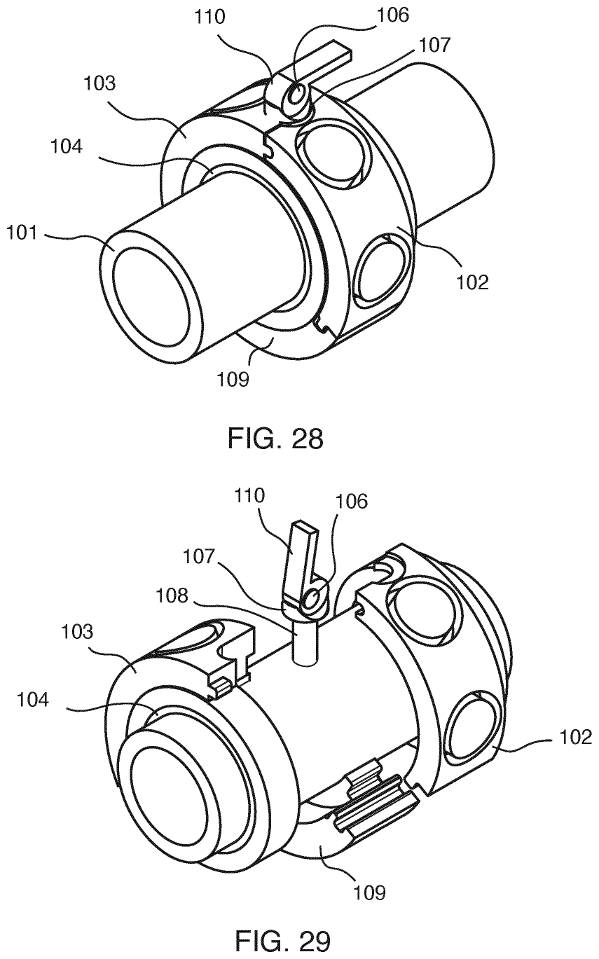

FIGS. 28 and 29 show a hub including a clamping arrangement for clamping the collars in the deployed position of the wheel.

FIG. 28 shows a hub in the deployed configuration of the wheel. A hub shaft (101), as second (102), and third (103) collar members interlocked with the third collar member (109), which is fixed to the hub shaft (101). A clamping member comprises a cam surface (105), mounted on a transverse shaft (106), and having a cam lever (110). The cam surface (105), has a variable radius from the transverse axis (106), so that a variable clamping force is applied to contact member (107). The contact member (107) is slidably mounted upon shaft (108) so that the clamping force is applied to both second and third collar members (102) (103) as the clamping member (110) and cam surface (105) are rotated by a user. A bearing (104) comprises a low friction polymeric material. A cylindrical sleeve manufactured by lgus may be employed.

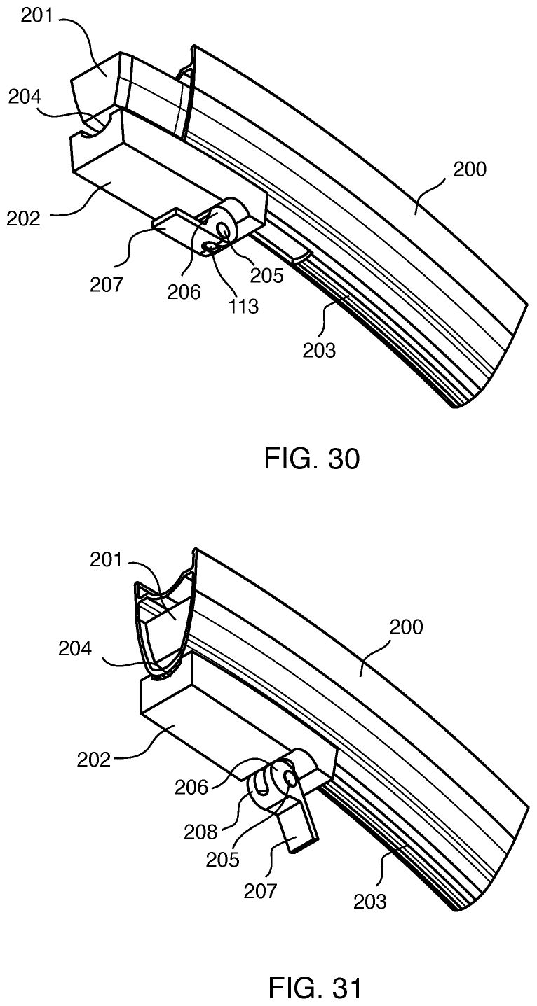

FIGS. 29 and 30 illustrate a rim clamping arrangement for securing adjacent rim sections in the deployed position of the wheel. The rim section (200) has an annular channel in which a slidable latch member (201) is slidable between locked and unlocked positions within the channel. A rim clamping member comprises a clamping plate (202) extending circumferentially in contact with the radially, inwardly-facing surface (203) of the rim (200). The clamping plate (202) has a circumferential concave channel (204) configured to slide over the corresponding convex surface of the radially, inwardly-facing rim surface (203). The clamping plate (202) is radially movable upon a projection (not shown) extending radially inwardly from a proximal engagement with the radially inner surface of sliding member (201) having a distal radially innermost portion upon which a transverse pivot pin (205) and cam member (206) are rotatably mounted. The radius of the cam surface (208) of the cam member (206) is dependent on angular location of the cam member so that raising or lowering of the cam lever (207) exerts a variable clamping force on the clamping member (202) to secure the clamping member (202) and sliding member (201) in relation to the rim (200). In the configuration shown in FIG. 33, two adjacent rim members may be secured together to prevent movement thereof during use of the wheel.

1. A bicycle wheel, comprising:
a hub comprising a plurality of hub members;
a rim; and
spoke members extending between the hub and the rim;
wherein the wheel comprises three or more sectors, each sector comprising a circumferential rim section, an axial hub member and one or more spoke members extending between the hub member and the rim portion;
wherein the wheel may be moved between a deployed configuration and a fully collapsed configuration;
wherein in the deployed configuration the rim portions form a continuous circular rim of the wheel;
wherein in the fully collapsed configuration the rim portions are arranged side by side in an axially adjacent arrangement; and
wherein the hub members engage and form an axially expandable or collapsible hub.

2. The bicycle wheel as claimed in claim 1, wherein the hub includes a shaft extending axially of the wheel; and further comprising:
a collar located co-axially around the shaft, the collar comprising three or more part cylindrical collar members, the collar members being axially slidable and rotatable in relation to the other collar members.

3. The bicycle wheel as claimed in claim 1, wherein each hub member comprises a respective collar member, each collar member forming the hub member or extending radially outwardly from the hub member.

4. The bicycle wheel as claimed in claim 3, wherein each collar member is axially slidable in relation to one or two other collar members.

5. The bicycle wheel as claimed in claim 3, wherein each collar member comprises a body having a part-cylindrical internal surface and one or more mountings for a spoke member, preferably two spokes, of a respective rim portion.

6. The bicycle wheel as claimed in claim 1, further comprising:
a first collar member secured to the hub shaft, the first collar member extending outwardly from the shaft, and having first and second engagement surfaces extending parallel to the axis of the shaft, each of the engagement surfaces being arranged for slidable engagement with a corresponding engagement surface of an adjacent collar member.

7. The bicycle wheel as claimed in claim 6, wherein each engagement surface includes a formation configured to engage a complementary formation of a corresponding engagement surface of an adjacent collar member.

8. The bicycle wheel as claimed in claim 6, wherein the or each projection comprises one or more axially extending ribs or spines, and
wherein the or each projection extends tangentially to the axis.

9. The bicycle wheel as claimed in claim 8, wherein the or each projection extends at a constant radius from the axis, and having a cylindrical profile.

10. The bicycle wheel as claimed in claim 8, wherein the engagement surfaces are planar or curved in cross-sectional profile.

11. The bicycle wheel as claimed in claim 1, further comprising:
first second and third collar members arranged around the cylindrical shaft member,
the first collar member being secured to or integral with the shaft and having first and second engagement surfaces arranged to engage and cooperate with a third engagement surface of a second collar member and a fourth engagement surface of a third collar member respectively; and
a fifth engagement surface of the second collar member being arranged to engage a sixth engagement surface of the third collar member.

12. The bicycle wheel as claimed in claim 8, wherein when the engagement surfaces are engaged in this way, the second, third or both collar members move slidingly along the shaft relative to each other and/or the first collar member and are prevented from axial rotation by abutment of each collar member between engagement surfaces of the two adjacent collar members.

13. The bicycle wheel as claimed in claim 6, wherein the engagement surfaces of the first collar member have one or more projections or recesses extending at a constant radius, so that the projections and recesses are part cylindrical in radial cross-section.

14. The bicycle wheel as claimed in claim 6, wherein the first collar member has one or more of: two recesses, one on each engagement surface; two projections, one on each engagement surface; or one projection and one engagement on one projection and one engagement surface and one recess on the other engagement surface.

15. The bicycle wheel as claimed in claim 6, wherein the second and third collar members slide axially along the shaft in opposite directions.

16. The bicycle wheel as claimed in claim 6, wherein a locking member secures one or both of the collar members to the shaft.

17. The bicycle wheel as claimed in claim 16, wherein the locking member comprises a pin that extends through a radially extending bore in the body of the second or third collar member and be received in a socket in the shaft, the pin being biased, for example by a spring, into the engaged position in which the pin is engaged within the socket so that movement of the collar relative to the shaft is prevented.

18. The bicycle wheel as claimed in claim 17, wherein the shaft includes one or more channels, the or each channels being configured to guide the pin as the respective collar member is moved axially along the shaft.

19. The bicycle wheel as claimed in claim 18, wherein the channel is configured to engage an end of the pin as the collar member is moved axially outwardly of the hub between the deployed position and towards the fully collapsed position.

20. The bicycle wheel as claimed in claim 19, further comprising a first channel in the shaft serves to guide the movement of the guide pin extending radially inwardly from the second hub member, the first channel extending parallel to the axis of the shaft for a first distance and between a first end and a second end and extending circumferentially from the second end at a constant location on the wheel axis.

21. The bicycle wheel as claimed in claim 20, further comprising a second channel in the surface of the shaft serving to guide movement of the third hub member.

22. The bicycle wheel as claimed in claim 21, wherein the first section of the second channel extends along the surface of the shaft in a spiral configuration and a second section of the second channel extends at a constant axial location along the wheel axis.

23. The bicycle wheel as claimed in claim 3, further comprising:
a collar clamp to secure the collar members in the deployed configuration of the wheel.

24. The bicycle wheel as claimed in claim 23, wherein the collar clamp is arranged to apply a radially, inwardly-directed force against a radially, outwardly-facing surface of two collar members.

25. The bicycle wheel as claimed in claim 1, wherein adjacent rim sections are secured together in the deployed position by a rim lock arrangement,
wherein the rim lock arrangement comprises a channel extending circumferentially into an end of each rim section and arranged to align with a corresponding channel extending into the end of an adjacent rim section to form a continuous channel in the deployed configuration of the wheel, and further comprising a latch member being located in the channel, the latch member being slidable between a retracted position wherein the latch member is located wholly within a single channel and an extended position wherein the latch member is located partially within each channel of two adjacent rim sections.

26. The bicycle wheel as claimed in claim 1, wherein each rim section supports a respective tyre section, each tyre section having end walls arranged to abut the end walls of an adjacent tyre section when the wheel is in the deployed configuration.

27. The bicycle wheel as claimed in claim 2, wherein a bearing is located between the shaft and collar.

28. The bicycle wheel as claimed in claim 25, wherein the rim lock arrangement comprises a rim clamping member engaging adjacent rims and applying a clamping force to the rims to prevent relative movement of the rims.

29. A foldable bicycle, comprising:
a frame; and
two wheels;
the frame comprising two parts connected together by lockable hinges and movable between a first position in which the frame is extended for riding by a user and a second position in which the frame is folded; a front wheel detachable from the frame; and
a rear wheel as claimed in claim 1.

30. A foldable bicycle, comprising:
a frame; and
two wheels;
the frame comprising two parts connected together by lockable hinges and movable between a first position in which the frame is extended for riding by a user and a second position in which the frame is folded; a front wheel and a rear wheel as claimed in claim 1.
